(19) United States
(12) Patent Application Publication
(10) Pub. No.: US 2018/0213463 A1
(43) Pub. Date: Jul. 26, 2018

(54) METHOD FOR PERFORMING TRAFFIC STEERING BETWEEN A FIRST ACCESS NETWORK AND A SECOND ACCESS NETWORK AND A COMMUNICATIONS APPARATUS UTILIZING THE SAME

(71) Applicant: MEDIATEK INC., Hsin-Chu (TW)

(72) Inventors: Pi-Yuan CHENG, Kaohsiung City (TW); Wenze QU, Beijing (CN)

(21) Appl. No.: 15/875,154

(22) Filed: Jan. 19, 2018

Related U.S. Application Data
(60) Provisional application No. 62/449,141, filed on Jan. 23, 2017.

(30) Foreign Application Priority Data
Jan. 10, 2018 (CN) 201810021803.3

(51) Int. Cl. H04W 40/14; H04W 36/14; H04W 36/16

(52) U.S. Cl. CPC H04W 40/14; H04W 36/165; H04W 36/14

(57) ABSTRACT

A method for performing traffic steering between a first access network and a second access network in a communications apparatus includes: monitoring a current status of the communications apparatus; determining whether the current status meets a predetermined condition; performing traffic steering between the first access network and the second access network according to network configurations when the current status meets the predetermined condition; and performing traffic steering between the first access network and the second access network according to the current status of the communications apparatus when the current status does not meet the predetermined condition.

### CROSS REFERENCE TO RELATED APPLICATIONS

This application claims the benefit of U.S. Provisional Application No. 62/449,141 filed on Jan. 23, 2017 and entitled “Apparatus and Methods for 3GPP/WLAN Interworking and Aggregation Decision” and China Patent Application No. 201810021803.3, filed on Jan. 10, 2018, and the entire contents of which are hereby incorporated by reference.

### BACKGROUND OF THE INVENTION

### Field of the Invention

The invention relates to methods for performing traffic steering between a first access network and a second access network to avoid inefficient wireless communication for a communications apparatus.

### Description of the Related Art

The term “wireless” normally refers to an electrical or electronic operation that is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best-known example of wireless communications is the cellular telephone. Cellular telephones use radio waves to enable an operator to make phone calls to another party from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signaling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. Wireless Fidelity (Wi-Fi) is a technology defined by the 802.11 engineering standard and can be used for home networks, mobile phones, and video games to provide a high-frequency wireless local area network. Long-Term Evolution (LTE) is a standard for wireless communication of high-speed data for mobile phones and data terminals. It is based on the GSM/EDGE and UMTS/HSPA network technologies, increasing the capacity and speed using a different radio interface together with core network improvements.

In order to provide more efficient communications services and improve user experience, methods for avoiding establishing an inefficient wireless connection for a communications apparatus are provided.

### BRIEF SUMMARY OF THE INVENTION

A communications apparatus and methods for performing traffic steering between a first access network and a second access network are provided. An exemplary embodiment of a communications apparatus comprises a first radio transceiver, a second radio transceiver and a processor. The first radio transceiver is configured to communicate with a first network device in a first access network in compliance with a first communications protocol. The second radio transceiver is configured to communicate with a second network device in a second access network in compliance with a second communications protocol. The processor is configured to monitor a current status of the communications apparatus and determine whether the current status meets a predetermined condition. When the current status meets the predetermined condition, the processor performs traffic steering between the first access network and the second access network according to network configurations. When the current status does not meet the predetermined condition, the processor performs traffic steering between the first access network and the second access network according to the current status of the communications apparatus

An exemplary embodiment of a method for performing traffic steering between a first access network and a second access network in a communications apparatus comprises: monitoring a current status of the communications apparatus; determining whether the current status meets a predetermined condition; performing traffic steering between the first access network and the second access network according to network configurations when the current status meets the predetermined condition; and performing traffic steering between the first access network and the second access network according to the current status of the communications apparatus when the current status does not meet the predetermined condition.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a modem according to an embodiment of the invention;

FIG. 3A shows an exemplary network architecture to support 3GPP-WLAN interworking;

FIG. 3B shows another exemplary network architecture to support 3GPP-WLAN interworking;

FIG. 4 shows an exemplary ePDG based 3GPP-WLAN interworking network architecture reference model;

FIG. 5 is a flow chart of a method for performing traffic steering between a first access network and a second access network according to an embodiment of the invention;

FIG. 6 is a flow chart of a method for performing traffic steering between a first access network and a second access network according to another embodiment of the invention; and

FIG. 7 is a flow chart of a method for performing traffic steering between a first access network and a second access network according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

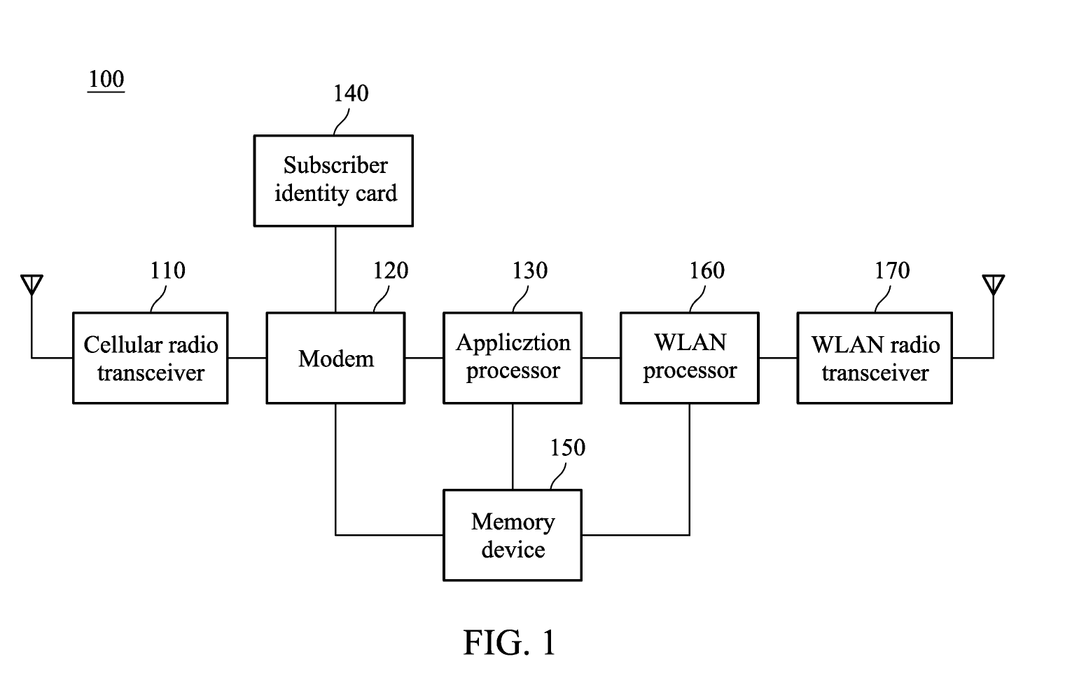

FIG. 1 shows an exemplary block diagram of a communications apparatus according to an embodiment of the invention. The communications apparatus 100 may be a portable electronic device or a mobile device, such as a Mobile Station (MS, which may be interchangeably referred to as User Equipment (UE)), and is capable of supporting cellular communications and non-cellular communications, such as wireless local area network (WLAN) communications. The communications apparatus 100 may comprise one or more antenna modules, wherein each antenna module may comprise one or more antennas, a cellular radio transceiver 110, a modem 120, an application processor 130, a subscriber identity card 140, a memory device, 150, a WLAN processor 160 and a WLAN radio transceiver 170. The cellular radio transceiver 110 is configured to communicate with a cellular network device (or, a 3GPP network device) in a cellular access network (or, a 3GPP access network) in compliance with a cellular communications protocol (or, a 3GPP communications protocol). The cellular radio transceiver 110 may receive wireless radio frequency signals from an air interface via the corresponding antenna module, transmit wireless radio frequency signals to the air interface via the corresponding antenna module and perform RF signal processing. For example, the cellular radio transceiver 110 may convert the received signals into intermediate frequency (IF) or baseband signals to be processed, or receive the IF or baseband signals from the modem 120 and convert the received signals into wireless radio frequency signals to be transmitted to a cellular network device. According to an embodiment of the invention, the cellular network device may be a cell, an evolved node B, a base station, etc., at the cellular network side and communicating with the communications apparatus 100 via the wireless radio frequency signals.

The cellular radio transceiver 110 may comprise a plurality of hardware devices to perform radio frequency conversion and RF signal processing. For example, the cellular radio transceiver 110 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a Long-Term Evolution (LTE) system, etc.

The modem 120 may be a cellular communications modem configured to handle cellular system communications protocol operations and processing the IF or baseband signals received from or to be transmitted to the cellular radio transceiver 110.

The application processor 130 is configured to run the operating system of the communications apparatus 100 and run application programs installed in the communications apparatus 100. The application processor 130 may further have some processing or computation abilities, such as multimedia data encoding/decoding, audio signal processing, interface connectivity, digital signal processing, or others.

In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory device 150 may be coupled to the modem 120, the application processor 130 and the WLAN processor 160 and may store system data or user data.

The WLAN radio transceiver 170 is configured to communicate with a WLAN network device (e.g., a non-3GPP network device) in a WLAN access network (e.g., a non-3GPP access network) in compliance with a WLAN communications protocol (e.g., a non-3GPP communications protocol). The WLAN radio transceiver 170 may receive wireless radio frequency signals from an air interface via the corresponding antenna module, transmit wireless radio frequency signals to the air interface via the corresponding antenna module and perform RF signal processing. For example, the WLAN radio transceiver 170 may convert the received signals into intermediate frequency (IF) or baseband signals to be processed, or receive the IF or baseband signals from the WLAN processor 140 and convert the received signals into wireless radio frequency signals to be transmitted to a WLAN network device. According to an embodiment of the invention, the WLAN network device may be a Wi-Fi hot-spot, a Wi-Fi access point, or any network device providing ISM band communications services in a wireless local area network and communicating with the communications apparatus 100 via the wireless radio frequency signals.

The WLAN radio transceiver 170 may comprise a plurality of hardware devices to perform radio frequency conversion and RF signal processing. For example, the WLAN radio transceiver 170 may comprise a power amplifier for amplifying the RF signals, a filter for filtering unwanted portions of the RF signals and/or a mixer for performing radio frequency conversion.

The WLAN processor 160 may receive the IF or baseband signals from the WLAN radio transceiver 170 and perform IF or baseband signal processing. The WLAN processor 160 may further execute the program codes of the corresponding software module to implement WLAN protocol and support WLAN protocol computations. The WLAN protocol may be defined in the Wi-Fi standards, the 802.11 series of standards, or the like.

The WLAN processor 160 is coupled to the application processor 130 of the communications apparatus 100. The application processor 130 may control the cooperation of the cellular communications and the WLAN communications for the communications apparatus 100.

It should be noted that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1.

It should be noted that, although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the cellular radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple cellular radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

It should be noted that the subscriber identity card 140 may be dedicated hardware cards as described above, or in some embodiments of the invention, there may be individual identifiers, numbers, addresses, or the like which are burned in the internal memory device of the corresponding modem and are capable of identifying the communications apparatus. Therefore, the invention should not be limited to what is shown in the figures.

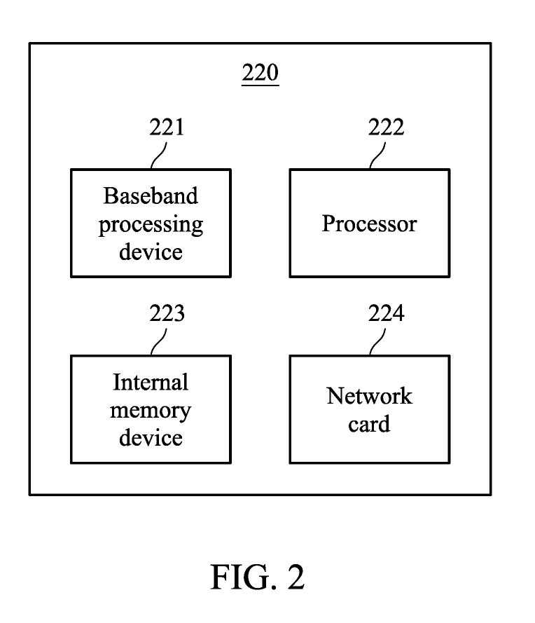

FIG. 2 shows an exemplary block diagram of a modem according to an embodiment of the invention. The modem 220 may be the modem 120 shown in FIG. 1 and may comprise at least a baseband processing device 221, a processor 222, an internal memory device 223 and a network card 224. The baseband processing device 221 may receive the IF or baseband signals from the cellular radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory device 223 may store system data and user data for the modem 220. The processor 222 may also access the internal memory device 223.

The network card 224 provides Internet access services for the communications apparatus. It should be noted that, although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be noted that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

It should be noted that in some embodiments of the invention, the baseband processing device 221 and the processor 222 may be integrated into one processing unit, and the modem may comprise one or more multiple such processing units, for supporting multi-RAT operations. Therefore, the invention should not be limited to what is shown in FIG. 2.

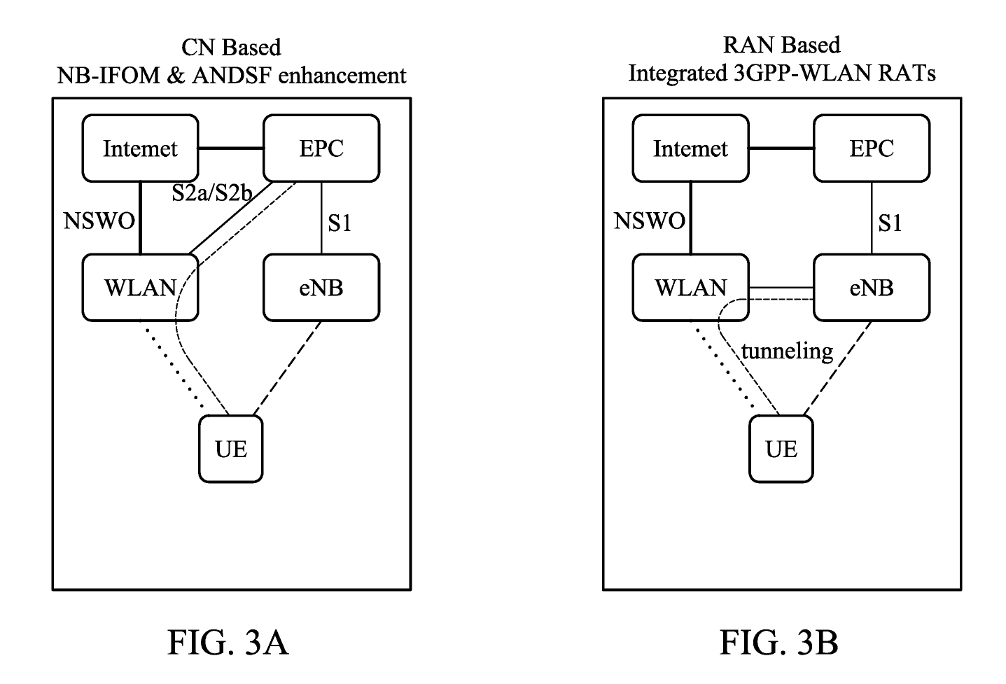

FIG. 3A shows an exemplary network architecture to support 3GPP-WLAN interworking. The architecture shown in FIG. 3A is a core network based (CN based) network architecture to support 3GPP-WLAN interworking. The UE access the Internet via either the WLAN network device (e.g. an access point) or the cellular network device (e.g. the eNB). The eNB may communicate with a serving gateway (S-GW) of the Evolved Packet Core (EPC) via an S1 interface. The WLAN network device may communicate with to an evolved packet data gateway (ePDG) of the EPC via a S2a and/or a S2b interface. The WLAN network device may also communicate directly with Internet entities to provide non-seamless WLAN offload (NSWO) of IP traffic between the UE and the Internet entities. NSWO may be used to support routing specific IP flows over the WLAN access network without traversing the EPC.

FIG. 3B shows another exemplary network architecture to support 3GPP-WLAN interworking. The architecture shown in FIG. 3B is a radio access network based (RAN based) network architecture to support 3GPP-WLAN interworking. A tunnel is created between the WLAN network device and the cellular network device (e.g. the eNB), so that the WLAN network device may communicate with the eNB via the tunnel.

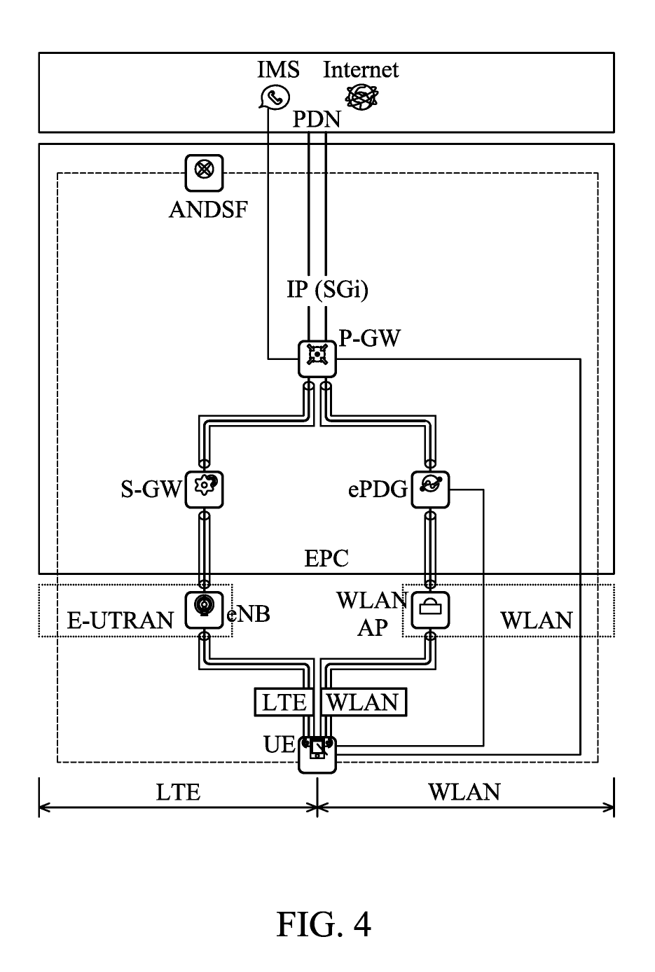

FIG. 4 shows an exemplary ePDG based 3GPP-WLAN interworking network architecture reference model. Inside an EPC, there is an entity called the access network discovery and selection function (ANDSF) which assists the UE to discover non-3GPP access networks, such as WLAN or Wi-Fi, that may be used for controlling offloading between 3GPP access networks (such as LTE) and non-3GPP access networks (such as WLAN or Wi-Fi). The ANDSF may also provide the UE with rules policing the connection to these networks. The serving gateway (S-GW) and ePDG may communicate with a packet gateway (P-GW) via a specific interface. The P-GW may communicate with Internet entities via an SGi interface.

In the existing design, the policies or rules for steering the traffic between 3GPP access networks and non-3GPP access networks may comprise at least an ANDSF rule and a RAN rule. The network device (such as the eNB) may indicate a communications apparatus (such as an UE) which policy is to be used via RRC signaling. For example, the network device may configure the policy or rule for traffic steering or making the offloading decision via a steering command.

In the ADNSF rule, the ANDSF server may provide qualities threshold and/or other parameters to the UE, and the UE may make the offloading decision based on measurement results and the qualities threshold and/or parameters configured by the network. In the RAN rule, the network device (e.g. the eNB) may provide quality measurement requirements to the UE. The UE may measure the qualities of the 3GPP and/or non-3GPP network devices, and report the measurement results to the eNB. The eNB may make the offloading decision based on measurement results.

When the non-3GPP access network (e.g. the WLAN or Wi-Fi) is determined to be used while the UE is currently operating in the 3GPP access network, the UE may transmit a handover indication to the serving gateway (S-GW) via NAS signaling, so as to handover or steer the traffic from the 3GPP access network to the non-3GPP access network.

When the 3GPP access network is determined to be used while the UE is currently using the non-3GPP access network, the UE may transmit a handover indication through the ePDG to the packet gateway (P-GW) via NAS signaling, so as to handover or steer the traffic from the non-3GPP access network to the 3GPP access network.

However, the existing policies or rules configured by the network are not made in consideration of a condition or status of the communications apparatus. Therefore, when the processor (e.g. the processor 222 in the modem 120/220 or the application processor 130) merely perform traffic steering between different access networks or make the offloading decision based on the network configurations (here, the network configurations may comprise the policy or rule indicated or configured by the network device and the qualities threshold, parameters and/or the quality measurement requirements provided by the network device), the offloading decision may not be suitable for the current status of the communications apparatus. In this manner, an undesired user experience may be brought to the user, and/or inefficient wireless communication may be established.

To solve these problems, methods for performing traffic steering between different access networks are provided.

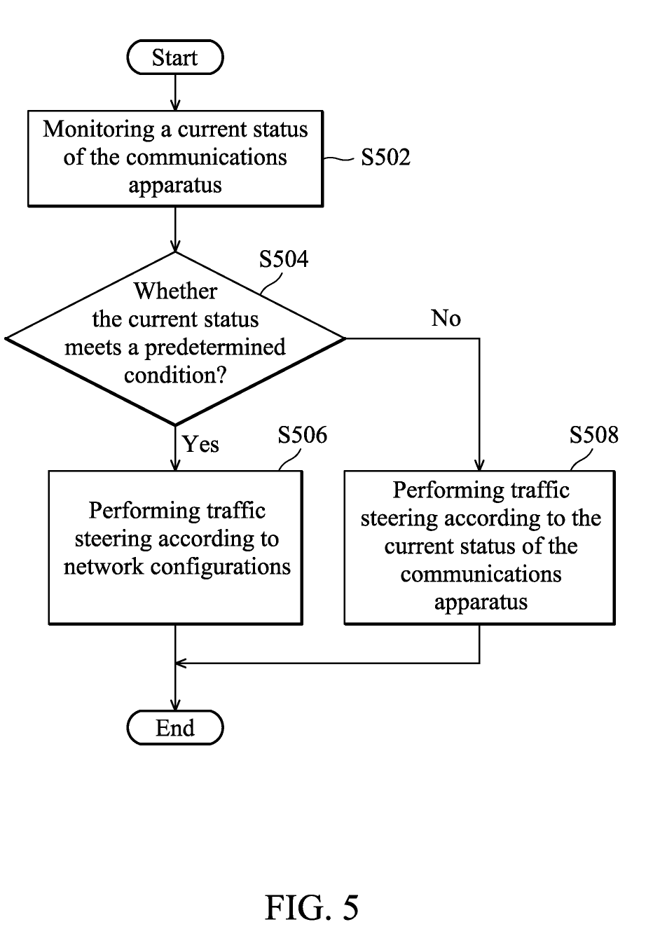

FIG. 5 is a flow chart of a method for performing traffic steering between a first access network and a second access network according to an embodiment of the invention. The processor (e.g. the processor 222 in the modem 120/220 or the application processor 130) of the communications apparatus may keep monitoring the current status of the communications apparatus (Step S502). According to an embodiment of the invention, when the functions of cellular communications and WLAN communications are both enabled by the user of the communications apparatus (for example, the user enables those functions via the user interface), the processor may start to keep monitoring the current status of the communications apparatus 100. According to another embodiment of the invention, the processor may start to keep monitoring the current status of the communications apparatus 100 when the communications apparatus 100 is operating in the 3GPP access network.

Next, the processor may determine whether the current status meets a predetermined condition (Step S504). The processor may check the current status of communications apparatus 100 periodically or non-periodically (for example, when triggered by some predefined or specific events). According to an embodiment of the invention, the current status of the communications apparatus 100 to be monitored may be selected from a group comprising: the battery status of the communications apparatus 100, the data packet size required by the current data traffic, the amount of radio interference of the communications apparatus 100, the moving speed of the communications apparatus 100, the preference settings of the communications apparatus 100, or other factors.

According to an embodiment of the invention, the predetermined condition may be defined based on, for example, a predetermined threshold of the remaining battery power, a predetermined upper boundary or lower boundary of a proper data packet size, an upper limit of data packet size that can be smoothly processed by the communications apparatus 100, an upper limit of the amount of radio interference due to multi-RAT communications, an upper limit of the moving speed of the communications apparatus 100, and a preference setting of “cellular-communications only” or “WLAN communications only”, or other conditions.

When the current status of the communications apparatus 100 meets the predetermined condition, the processor may determine to perform traffic steering between the first access network and the second access network according to network configurations (Step S506). As discussed above, the network configurations may comprise the policy or rule indicated or configured by a network device (such as an eNB) and the qualities threshold, parameters and/or the quality measurement requirements provided by the network device. In this manner, the processor evaluates the traffic steering based on the traffic steering rule configured by the network device.

For example, when the remaining battery power of the communications apparatus 100 is greater than the predetermined threshold, the processor may determine to perform traffic steering according to network configurations. In another example, when the data packet size required by a current data traffic does not exceed the upper limit of data packet size that can be smoothly processed by the communications apparatus 100, the processor may determine to perform traffic steering according to network configurations. In another example, when the amount of radio interference due to multi-RAT (such as the cellular and non-cellular) communications does not exceed the upper limit, the processor may determine to perform traffic steering according to network configurations. In another example, when the moving speed of the communications apparatus 100 does not exceed the upper limit, the processor may determine to perform traffic steering according to network configurations.

Note that in order to illustrate the concept of the invention, some examples are provided above. However, it should be understood that those who are skilled in this technology can still make various alterations and modifications based on their design requirements, and the invention should not be limited thereto.

On the other hand, when the current status of the communications apparatus 100 does not meet the predetermined condition, the processor may determine to perform traffic steering between the first access network and the second access network according to the current status of the communications apparatus (Step S508), instead of the network configurations. In other words, when the current status of the communications apparatus 100 does not meet the predetermined condition, even if the network device (such as the eNB) has indicated the communications apparatus 100 which traffic steering policy is to be used, the communications apparatus 100 still determines not to apply, not to use or not to follow the traffic steering policy indicated by the network device to evaluate the traffic steering.

According to an embodiment of the invention, the traffic steering rule may be the ANDSF rule, the RAN rule, or some other traffic steering rule defined later for 3GPP-WLAN interworking.

When the processor determines to perform traffic steering between the first access network and the second access network according to the current status of the communications apparatus, the processor may determine to steer the traffic to a access network for the communications apparatus 100 not to cause undesired user experience to the user, and/or not to establish an inefficient wireless communication. For example, when the remaining battery power of the communications apparatus 100 is not greater than the predetermined threshold, the processor may determine to steer the traffic to a non-3GPP access network (such as the WLAN access network) since the 3GPP or cellular communications generally consumes more power than the WLAN communications.

In another example, when the amount of radio interference due to multi-RAT (such as the cellular and non-cellular) communications exceeds the upper limit, the processor may determine to steer the traffic to only one of the cellular or non-cellular access network, and will not apply or not follow the traffic steering policy indicated by the network device, so as to avoid the aggregation service (such as the LTE-WLAN Aggregation (LWA) or the LTE WLAN Radio Level Integration with IPsec Tunnel (LWIP)) that would induce sever radio interference being activated by the eNB.

In another example, when the moving speed of the communications apparatus 100 exceeds the upper limit, the processor may determine to steer the traffic to the 3GPP access network (such as the LTE access network) since it is more suitable for high speed communications.

In the following paragraphs, more detailed flow charts of the methods for performing traffic steering are provided.

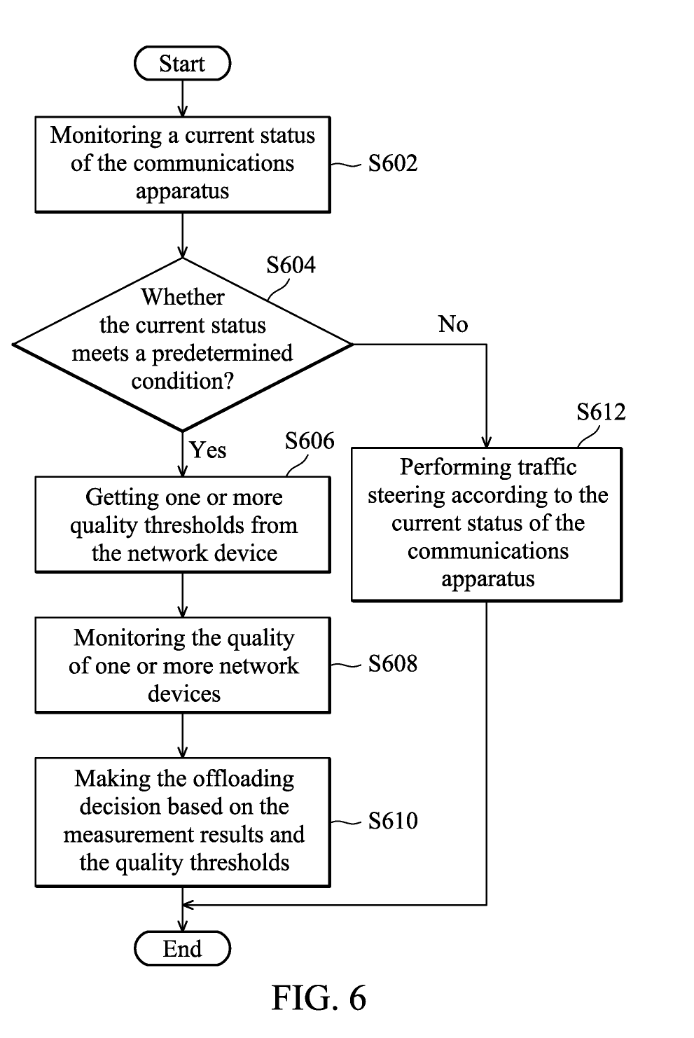

FIG. 6 is a flow chart of a method for performing traffic steering between a first access network and a second access network according to another embodiment of the invention. In this embodiment, the network device (e.g. the eNB) has indicated the communications apparatus that the ANDSF rule is to be used. First of all, the processor (e.g. the processor 222 in the modem 120/220 or the application processor 130) of the communications apparatus may keep monitoring the current status of the communications apparatus (Step S602). Next, the processor may determine whether the current status meets a predetermined condition (Step S604). When the current status of the communications apparatus 100 meets the predetermined condition, the processor may apply the ANDSF rule to get one or more quality thresholds from the network device (Step S606), and monitor (e.g. measure) quality of the first network device (e.g. the eNB) and/or the second network device (e.g. the access point) for evaluating the traffic steering (Step S608). The processor may then make the offloading decision based on the measurement results and the quality thresholds obtained from the network device (Step S610). Steps S606, S608 and S610 are the exemplary steps of the traffic steering solution based on the ANDSF rule.

On the other hand, when the current status of the communications apparatus 100 does not meet the predetermined condition, the processor may determine not to evaluate the traffic steering based on the ANDSF rule. For example, the processor may not monitor (e.g. measure) quality of the network devices or may not evaluate the traffic steering according to quality of the network devices. Instead, the processor may determine to perform traffic steering between the first access network and the second access network according to the current status of the communications apparatus (Step S612). For example, even when the LTE/Wi-Fi qualities have satisfied the quality thresholds obtained from the network device and should be chosen based on the ANDSF rule, the processor may still determine to steer the traffic to the Wi-Fi/LTE access network. In another example, even when both the LTE and Wi-Fi qualities have satisfied the quality thresholds obtained from the network device and the aggregation service should be activated based on the ANDSF rule, the processor may still determine to steer the traffic to only one of the Wi-Fi or LTE access network because, for example, the remaining battery power of the communications apparatus 100 is not greater than the predetermined threshold or the current data traffic exceeds the upper limit of data packet size that can be smoothly processed by the communications apparatus.

When further considering the current status of the communications apparatus 100 as discussed above, undesired user experience or inefficient wireless communication can be avoided.

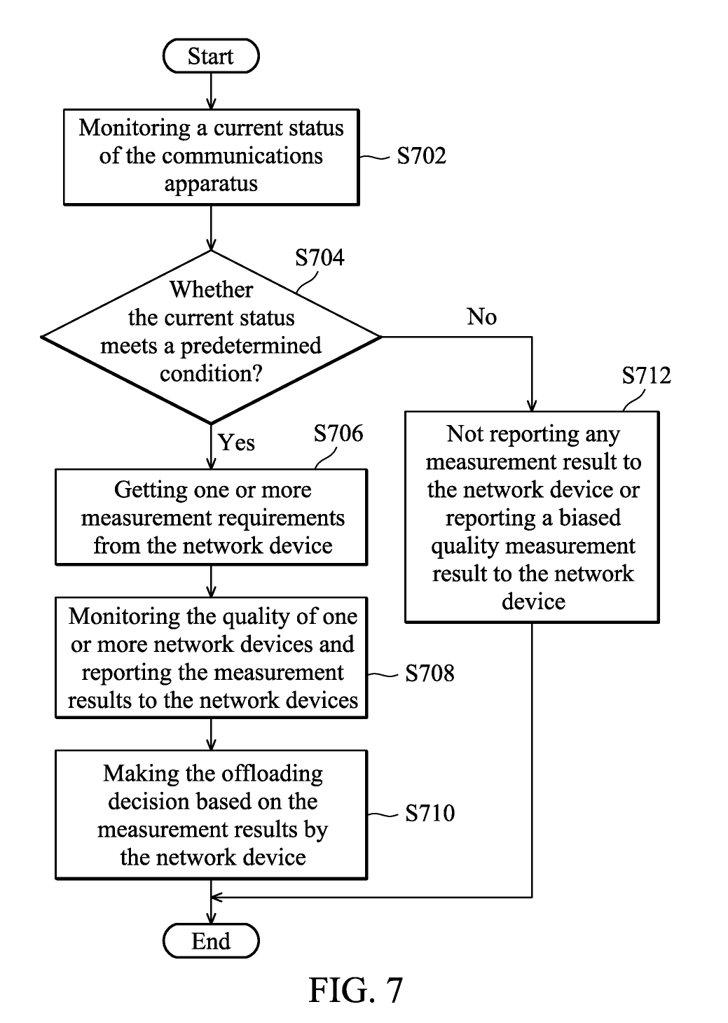

FIG. 7 is a flow chart of a method for performing traffic steering between a first access network and a second access network according to another embodiment of the invention. In this embodiment, the network device (e.g. the eNB) has indicated the communications apparatus that the RAN rule is to be used. First of all, the processor (e.g. the processor 222 in the modem 120/220 or the application processor 130) of the communications apparatus may keep monitoring the current status of the communications apparatus (Step S702). Next, the processor may determine whether the current status meets a predetermined condition (Step S704). When the current status of the communications apparatus 100 meets the predetermined condition, the processor may apply the RAN rule to get one or more measurement requirements from the network device (Step S706), and monitor (e.g. measure) quality of the first network device (e.g. the eNB) and/or the second network device (e.g. the access point) and report the measurement results to the network device (Step S708). The network device may then make the offloading decision based on the measurement results (Step S710). The network device may further notify the communications apparatus about the offloading decision. Steps S706, S708 and S710 are the exemplary steps of the traffic steering solution based on the RAN rule.

On the other hand, when the current status of the communications apparatus 100 does not meet the predetermined condition, the processor may determine not to evaluate the traffic steering based on the RAN rule. For example, the processor may not monitor (e.g. measure) quality of the network devices or may not report the actual measurement results to the network device. Instead, the processor may report a biased quality measurement result to the network device (Step S712).

According to an embodiment of the invention, the processor may make the offloading decision according to the current status of the communications apparatus and determine the biased quality measurement result based on its offloading decision, so as to lead the network device to make the same offloading decision as the processor. According to another embodiment of the invention, the processor may also not report any measurement result to the network device (Step S712), so as to lead the network device to make the same offloading decision as the processor based on previous measurement result.

For example, when the LTE/Wi-Fi has good quality and should be selected by the network device based on the RAN rule but the processor prefers to select the Wi-Fi/LTE, the processor may report very bad LTE/Wi-Fi quality to the network device, so as to lead the network device to select the Wi-Fi/LTE access network.

In another example, when both the LTE and Wi-Fi have good quality and the aggregation service should be activated based on the RAN rule but the processor prefers to steer the traffic to only one of the Wi-Fi or LTE access network because, for example, the remaining battery power of the communications apparatus 100 is not greater than the predetermined threshold or the current data traffic exceeds the upper limit of data packet size that can be smoothly processed by the communications apparatus, the processor may report very bad LTE or Wi-Fi quality to the network device, so as to lead the network device not to activate or disable the aggregation service.

Note that in some other embodiments of the invention, the processor may still report the actual measurement results to the network device, but does not follow the offloading decision made by the network device when the offloading decision made by the network device is different from the preferred one of the processor. Or, no matter whether the processor reports the actual measurement results or the biased measurement results to the network device, the processor may not follow the offloading decision made by the network device when the offloading decision made by the network device is different from the preferred one of the processor. The processor may respond an error message to the network device to deceive the network device that some error has occurred so that the offloading decision made by the network device is not applied.

Based on the embodiments discussed above, when further considering the current status of the communications apparatus 100 as discussed above, undesired user experience or inefficient wireless communication can be avoided.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a first radio transceiver, configured to communicate with a first network device in a first access network in compliance with a first communications protocol;
a second radio transceiver, configured to communicate with a second network device in a second access network in compliance with a second communications protocol; and
a processor, configured to monitor a current status of the communications apparatus and determine whether the current status meets a predetermined condition,
wherein when the current status meets the predetermined condition, the processor performs traffic steering between the first access network and the second access network according to network configurations, and
wherein when the current status does not meet the predetermined condition, the processor performs traffic steering between the first access network and the second access network according to the current status of the communications apparatus.

2. The communications apparatus as claimed in claim 1, wherein when the processor performs traffic steering according to network configurations, the processor evaluates the traffic steering based on a traffic steering rule configured by the first network device.

3. The communications apparatus as claimed in claim 2, wherein the traffic steering rule is an Access Network Discovery and Selection Functions (ANDSF) rule or a Radio Access Network (RAN) rule.

4. The communications apparatus as claimed in claim 1, wherein the current status of the communications apparatus is selected from a group comprising a battery status of the communications apparatus, a data packet size required by a current data traffic, an amount of radio interference of the communications apparatus, a moving speed of the communications apparatus and preference settings of the communications apparatus.

5. The communications apparatus as claimed in claim 2, wherein when the processor performs traffic steering according to the current status of the communications apparatus, the processor evaluates the traffic steering based on the current status of the communications apparatus instead of the traffic steering rule configured by the first network device.

6. The communications apparatus as claimed in claim 1, wherein when the processor performs traffic steering according to the current status of the communications apparatus, the processor does not monitor quality of the first network device and/or the second network device when performing traffic steering.

7. The communications apparatus as claimed in claim 1, wherein when a traffic steering rule configured by the first network device is an ANDSF rule and when the processor performs traffic steering according to the current status of the communications apparatus, the processor does not evaluate the traffic steering according to quality of the first network device and/or the second network device.

8. The communications apparatus as claimed in claim 1, wherein when a traffic steering rule configured by the first network device is an RAN rule and when the processor performs traffic steering according to the current status of the communications apparatus, the processor reports a biased quality measurement result instead of an actual quality measurement result to the first network device.

9. A method for performing traffic steering between a first access network and a second access network in a communications apparatus, comprising:
monitoring a current status of the communications apparatus;
determining whether the current status meets a predetermined condition;
performing traffic steering between the first access network and the second access network according to network configurations when the current status meets the predetermined condition; and
performing traffic steering between the first access network and the second access network according to the current status of the communications apparatus when the current status does not meet the predetermined condition.

10. The method as claimed in claim 9, wherein the step of performing traffic steering between the first access network and the second access network according to network configurations further comprises:
evaluating the traffic steering based on a traffic steering rule configured by a network device.

11. The method as claimed in claim 10, wherein the traffic steering rule is an Access Network Discovery and Selection Functions (ANDSF) rule or a Radio Access Network (RAN) rule.

12. The method as claimed in claim 9, wherein the current status of the communications apparatus is selected from a group comprising a battery status of the communications apparatus, a data packet size required by a current data traffic, an amount of radio interference of the communications apparatus, a moving speed of the communications apparatus and preference settings of the communications apparatus.

13. The method as claimed in claim 10, wherein the step of performing traffic steering between the first access network and the second access network according to the current status of the communications apparatus further comprises:
not using the traffic steering rule configured by the network device to evaluate the traffic steering.

14. The method as claimed in claim 9, wherein when a traffic steering rule configured by a network device is an ANDSF rule, the step of performing traffic steering between the first access network and the second access network according to the current status of the communications apparatus further comprises:
not evaluating the traffic steering according to quality of one or more network devices in the first access network and/or the second access network.

15. The method as claimed in claim 9, wherein when a traffic steering rule configured by a network device is an RAN rule, the step of performing traffic steering between the first access network and the second access network according to the current status of the communications apparatus further comprises:
reporting a biased quality measurement result instead of an actual quality measurement result to the network device.
